(19) United States
(12) Patent Application Publication
(10) Pub. No.: US 2004/0052926 A1
(43) Pub. Date: Mar. 18, 2004

(54) Dietetic food for breaking down fat

(76) Inventor: Udo Apfelbaum, Berneck (CH)

Correspondence Address: PETER E ROSDEN, 1505 LONDON ROAD, CHARLOTTESVILLE, VA, 229018881

(21) Appl. No.: 10/333,877

(22) PCT Filed: Jul. 27, 2001
(86) PCT No.: PCT/EP01/08731

(30) Foreign Application Priority Data
Jul. 27, 2000 (DE) 200 12 857.4

(51) Int. Cl. A23L 1/30

(52) U.S. Cl. 426/648

(57) ABSTRACT

The description relates to a dietetic food for breaking down fats, the use of which reduces the hungry feeling during the dieting period. This is achieved due to the fact that the dietetic food contains MCT. The class of compounds known under the name MCT (“medium-chain triglycerides”) comprises triglycerides of fatty acids of medium chain length wherein fatty acids of medium chain length means in particular C₈-C₁₂ fatty acids. MCT as such is a known substance, e.g. as Delios V and Delios C. It is of oily consistency. What is new is the use of this substance as dietetic food for regulating the fat metabolism, supplemented by L carnitine, in particular in the form of L carnitine-tartrate which serves as transport protein in order to transport long chain fats from body stores into the mitocondria for burning, whereby L carnitine can help to speed up the breaking down of fats, and supplemented by the co-enzyme Q10 which is lipophile and takes part in the reactions of the fatty acids in the field of the energy-supplying cell reactions, and possibly further supplemented by Omega3 fatty acids. In this function it can even more speed up an enhanced burning of fats.

The invention relates to a dietetic food for use in the case of a disturbed fat metabolism in persons with special physiologic conditions such as obesity.

Numerous foodstuffs of this kind are known which try to achieve this result by means of fibers, pure protein supply, speeding up of the digestion process, etc. In the human organism, the breakdown of fat—after a number of intermediate steps—follows after all the same principles as the breakdown of carbohydrates. A reduced fat intake thus leads to an increased insulin emission. In consequence thereof the endogenous carbohydrate stores are depleted and an increased hungry feeling sets in. Lipases play a role in breaking down fats and for the hungry feeling; of particular importance in this respect are lipoprotein lipases which are located at the endothelium of the vessels. From there a signal that energy is missing is issued, thus causing hunger. The result may then be that the person in question feels tempted to overcome his hunger by eating more.

In contrast to this the object underlying the invention is to reduce the hungry feeling during the dieting period. This is achieved by the measure that the dietetic food according to the present invention contains MCT. The class of compounds known under the name MCT (“medium-chain triglycerides”) comprises triglycerides of fatty acids of medium chain length, wherein “fatty acids of medium chain length” means in particular C₈-C₁₂ fatty acids. MCT as such is a known substance, e.g. as Delios V and Delios C. It is of oily consistency What is new is the use of this substance as dietetic food for regulating the fat metabolism, supplemented by L carnitine, in particular in the form of L carnitine tartrate which serves as transport protein in order to transport long chain fats from body stores Into the mitochondria for burning, whereby L carnitine can help to speed up the breaking down of fats, and supplemented by the co-enzyme Q10 which is lipophile and takes part in the reactions of the fatty acids in the field of the energy-supplying cell reactions. In this function it can even more speed up an enhanced burning of fats.

MCT is absorbed through the intestine wall without having been split, and as energy source for the body it is superior to carbohydrates due to its double calorific value. Furthermore, the energy is available upon avoidance of the “insulin pump” so that practically no hungry feeling occurs. When it comes to reducing weight, MCT acts such that the person in question loses weight due to a change in his metabolism. For example, if the person in question leaves out one main meal and works out regularly, MCT forces him under observation of the rules into the fat metabolism—contrary to the carbohydrate metabolism—thus using up calories. MCT seems to block or cover the lipoprotein lipase thus reducing the hungry feeling. It has been noted that with the help of the inventive dietetic food no hunger occurs for up to six hours. While normally the fat metabolism is only activated by long physical labor, MCT in combination with L carnitine and the co-enzyme Q10 very quickly activates the fat metabolism, e.g. within ten minutes. The very large stores of endogenous fats are affected and mobilized by means of a little MCT in combination with the other supplements. In order to support the burning process it is advisable to add molybdenum as salt, in particular in the form of molybdenum yeast. This helps mainly in the case of meteorisms and digesting of fats and via the enzyme xantinoxidaser c ntaining m lybdenum builds up uric add which serves as important catcher of free radicals which are easily produced during the process of losing weight. Furthermore, it is advisable to add a small amount of manganese which is a deficiency trace element and supports the fat metabolism.

Finally, it has been shown that the tolerability is further increased if a small amount of carbohydrates, especially maltodextrin, is contained in the inventive food.

The appropriate amounts can be taken from the dependent claims. By means of convenient flavors and fillers the food can be brought into a form that is acceptable to the users. It then comes as a gel or a paste.

Omega-3 fatty acids are an advantageous supplement to the dietetic food.

1. Dietetic food for breaking down fat, containing as main ingredient MCT and as further ingredients L carnitine and the co-enzyme Q10.

2. Food according to claim 1, further containing molybdenum and manganese in the form of salts.

3. Food according to claim 2, characterized in that the molybdenum salt is contained in the form of molybdenum yeast.

4. Food according to claim 2 or 3, characterized in that the manganese salt is manganese(II)carbonate.

5. Food according to claim 3 or 4, characterized in that it contains 0.15 to 2 weight percent molybdenum yeast with approx. 2000 mcg Mo/g, and 0.01 to 0.03 weight percent manganese(II)carbonate hydrate.

6. Food according to any one of claims 1-5, characterized in that the MCT is contained in an amount of 70-80 weight percent in respect of the total weight of the composition.

7. Food according to any one of claims 1-6, containing a small amount of carbohydrates.

8. Food according to claim 7, characterized in that the carbohydrates are contained in an amount of 5-8 weight percent in respect of the total weight of the composition, preferably in the form of maltodextrin.

9. Food according to any one of claims 1-8, characterized in that the L carnitine is present in the form of L carnitine tartrate which is contained in an amount of 2-3 weight percent and the co-enzyme Q10 is contained in an amount of 0.08 to 1 weight percent.

10. Food according to any one of claims 1-9, further containing Omega3 fatty acids.
